(19) United States
(12) Patent Application Publication
(10) Pub. No.: US 2023/0153788 A1
(43) Pub. Date: May 18, 2023

(54) PERFORMING CARD LIFECYCLE ACTIONS FOR CARD ACCOUNTS UTILIZING ENCRYPTION AND DOUBLE SIGNATURE VALIDATION

(71) Applicant: Marqeta, Inc., Oakland, CA (US)

(72) Inventors: Temenuzhka Thede, Newark, CA (US); Ronnie Flathers, Northbrook, IL (US); Tamas Henning, Cedarburg, WI (US)

(21) Appl. No.: 17/530,060

(22) Filed: Nov. 18, 2021

(51) Int. Cl. G06Q 20/34; H04L 9/08; H04L 9/32; G06Q 20/40

(52) U.S. Cl. CPC G06Q 20/341; H04L 9/0819; H04L 9/3228; H04L 9/3247; G06Q 20/354; G06Q 20/401; H04L 2209/56

(57) ABSTRACT

This disclosure describes methods, non-transitory computer readable storage media, and systems that utilize encryption and double signature validation to perform card lifecycle actions for card accounts. In connection with a request to perform a card lifecycle action (e.g., setting a personal identification number) for a card account, the disclosed system provides an encryption key set to an issuing system server that issued the request. The disclosed system receives an encrypted request message from the issuing system server encrypted utilizing the encryption key set provided to the issuing system server and signed by the issuing system server and a client device. Additionally, the disclosed system validates that the signatures from the encrypted request message correspond to the issuing system server and the client device of the user. The disclosed system also decrypts the encrypted request message and performs the card lifecycle action based on data in the decrypted request message.

### BACKGROUND

Electronic payment transactions and online banking via client devices (e.g., desktop devices and mobile devices) are increasingly prevalent. For example, many entities (e.g., banks) provide tools that allow customers to engage in payment transactions with other users (e.g., peer-to-peer payment transactions or peer-to-business payment transactions). Additionally, many entities have provided online availability of a number of operations by providing websites and proprietary applications. To illustrate, these websites and proprietary applications include tools for viewing information associated with customer accounts or performing other operations associated with the customer accounts.

While many existing systems provide online availability of a number of operations, these conventional systems continue to exclude online availability of some operations. In particular, some operations involved with banking entities or other financial entities (e.g., credit/debit card providers) require additional security measures that are difficult to verify through online communications. Due to the increased difficulty of providing adequate security of information exchange for such operations through online communications, the conventional systems restrict the performance of these operations to in-person or telephonic communications. In many instances, performing such operations online while complying with electronic payment standards is not possible via the infrastructure/design of the conventional systems. Accordingly, the conventional systems suffer from a number of disadvantages in security for online banking operations.

### SUMMARY

This disclosure describes one or more embodiments of methods, non-transitory computer readable media, and systems that solve the foregoing problems (in addition to providing other benefits) by utilizing encryption and double signature validation to perform card lifecycle actions for card accounts. Specifically, in one or more embodiments, in connection with a request to perform a card lifecycle action (e.g., setting a personal identification number) for a card account of a user, the disclosed systems provide an encryption key set to an issuing system server that issued the request. The disclosed systems then receive an encrypted request message from the issuing system server encrypted utilizing the encryption key set provided to the issuing system server and signed by the issuing system server and a client device of the user. Additionally, the disclosed systems validate that the signatures from the encrypted request message correspond to the issuing system server and the client device of the user. The disclosed systems also decrypt the encrypted request message and perform the card lifecycle action based on data in the decrypted request message. By utilizing encryption and double signature validation of requests to perform card lifecycle actions, the disclosed systems provide secure communications involving issuing system servers and user client devices.

### BRIEF DESCRIPTION OF THE DRAWINGS

The detailed description refers to the drawings briefly described below.

FIG. 1 illustrates a block diagram of a system environment in which a card lifecycle encryption system is implemented in accordance with one or more implementations.

FIGS. 2A-2B illustrate sequence-flow diagrams of a process for utilizing encryption and double signatures for electronic communications in connection with performing card lifecycle actions for a card account in accordance with one or more implementations.

FIGS. 3A-3B illustrate graphical user interfaces for creating a personal identification number for a card account in accordance with one or more implementations.

FIGS. 4A-4B illustrate graphical user interfaces for revealing a personal identification number for a card account in accordance with one or more implementations.

FIGS. 5A-5B illustrate graphical user interfaces for activating a card for a card account in accordance with one or more implementations.

FIGS. 6A-6B illustrate graphical user interfaces for disabling a card for a card account in accordance with one or more implementations.

FIG. 7 illustrates a flowchart of a series of acts for utilizing encryption and double signatures for electronic communications in connection with performing card lifecycle actions in accordance with one or more implementations.

FIG. 8 illustrates a block diagram of an exemplary computing device in accordance with one or more implementations.

### DETAILED DESCRIPTION

This disclosure describes one or more embodiments of a card lifecycle encryption system that performs card lifecycle actions based on encrypted request messages that are double signed by devices/servers that handle the request messages. Specifically, the card lifecycle encryption system receives from an issuing system server an indication of a request to perform a card lifecycle action associated with a card account (e.g., a payment card account) of a user. In connection with the indication of the request, the card lifecycle encryption system provides an encryption key set to a client device of the user to encrypt a request message associated with the card lifecycle action. The card lifecycle encryption system receives an encrypted request message that is encrypted with the encryption key set and signed by the client device and the issuing system server. The card lifecycle encryption system then performs the card lifecycle action after validating the signatures and decrypting the encrypted request message. The card lifecycle encryption system thus verifies the identities of devices involved in the request message and the contents of the request message.

As mentioned, in one or more embodiments, the card lifecycle encryption system receives an indication of a request to perform a card lifecycle action associated with a card account of a user. Specifically, the card lifecycle encryption system receives an indication from an issuing system server that a client device is requesting to perform the card lifecycle action for the card account of the user. For example, the client device can request to perform a card lifecycle action including setting a personal identification number (“PIN”), revealing a PIN, activating a card, or disabling a card for the card account of the user.

In one or more embodiments, the card lifecycle encryption system provides an encryption key set to the issuing system server for encrypting messages from the client device. For example, the card lifecycle encryption system provides the encryption key set to the issuing system server in response to receiving the indication of the request to perform the card lifecycle action. Additionally, in some embodiments, the card lifecycle encryption system provides a one-time access token to the issuing system server for authenticating communications from the issuing system server to the card lifecycle encryption system in connection with the request to perform the card lifecycle action.

In one or more embodiments, after the card lifecycle encryption system provides an encryption key set to an issuing system server, the issuing system server provides the encryption key set to a client device of a user. The client device generates and encrypts a request message including data associated with the card lifecycle action utilizing the encryption key set. Additionally, the client device signs the encrypted request message and sends the encrypted request message to the issuing system server. In one or more embodiments, the issuing system server validates the signed message, signs the encrypted request message, and passes the encrypted request message to the card lifecycle encryption system.

According to one or more embodiments, the card lifecycle encryption system validates signatures of an encrypted request message received from an issuing system server. Specifically, the card lifecycle encryption system verifies identities of a client device and an issuing system server involved in a request to perform a card lifecycle action for a card account. The card lifecycle encryption system can also authenticate the encrypted request message received from the issuing system server based on the inclusion of the one-time access token with the encrypted request message. The card lifecycle encryption system then decrypts the encrypted request message according to the previously provided encryption key set.

Upon validating and decrypting an encrypted request message from an issuing system server, the card lifecycle encryption system performs a card lifecycle action associated with the request message. In particular, the card lifecycle encryption system accesses the contents of the request message to determine the specific card lifecycle action and/or other details for performing the card lifecycle action. The card lifecycle encryption system can then generate a status code to provide to the issuing system server in a response message in connection with the request. Accordingly, the issuing system server can provide the status code or other response data to the client device of the user for displaying a message at the client device in connection with the card lifecycle action.

The disclosed card lifecycle encryption system provides a number of benefits over conventional systems. For example, the card lifecycle encryption system improves the security and flexibility of computing devices and systems that manage card account data and interact with issuing systems. In contrast to existing systems that are unable to securely perform card lifecycle actions associated with card accounts due to architecture and communication limitations, the card lifecycle encryption system securely communicates with issuing system servers and other devices in connection with performing card lifecycle actions. Specifically, the card lifecycle encryption system utilizes encryption authentication and double signature validation with any communications involving sensitive card data in a process for performing card lifecycle actions for card accounts. For instance, the card lifecycle encryption system utilizes encryption and signature validation to securely verify the identities of devices sending request messages and the contents of the request messages for card lifecycle actions. This allows the card lifecycle encryption system to mitigate men-in-the-middle attacks or attacks stemming from customers of the card lifecycle encryption system.

Furthermore, the card lifecycle encryption system improves the flexibility of computing systems that manage card account data and interact with issuing systems. In particular, by improving the security of communications involving card lifecycle actions utilizing encryption and double signature validation, the card lifecycle encryption system also improves the flexibility of the computing systems. For example, in contrast to conventional systems that are limited to performing a limited set of actions via online communication methods, the card lifecycle encryption system provides increased availability of actions via secure online communications.

Additionally, by leveraging encryption and double signing for card lifecycle action requests, the card lifecycle encryption system 102 removes the burden of maintaining compliance standards for issuing systems involved in the card lifecycle management workflow. Specifically, the card lifecycle encryption system 102 only provides an issuing system with an encryption key set (e.g., a public key) used for envelope encryption of request messages for card lifecycle action requests. Accordingly, the issuing system does not have access to the contents of the request message, and is thus not required to meet compliance standards for such communications. This also improves efficiency and simplicity of computing systems and integration of issuing systems involved in the card lifecycle workflow.

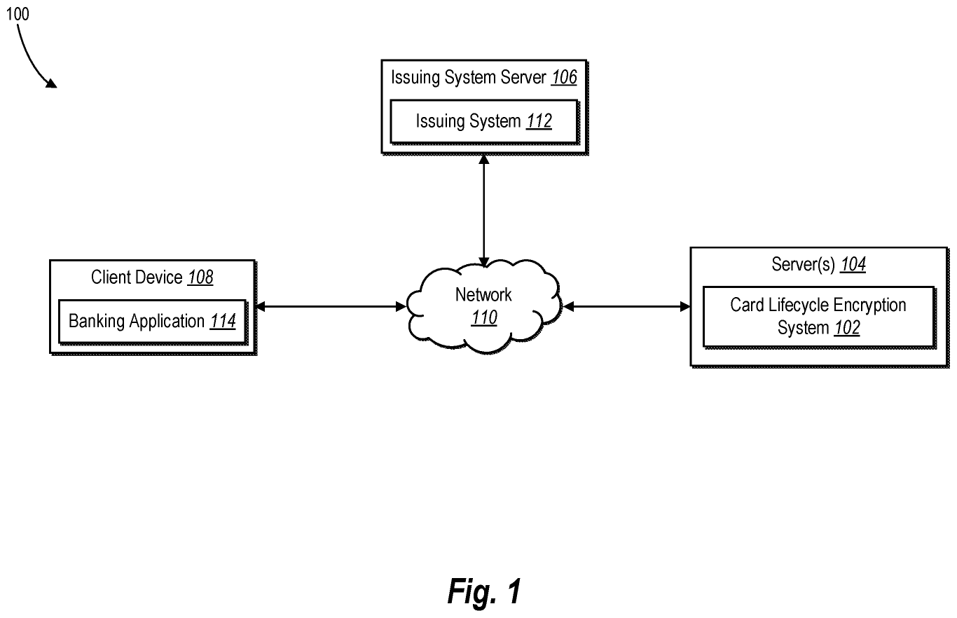

Turning now to the figures, FIG. 1 includes an embodiment of a system environment 100 in which a card lifecycle encryption system 102 operates. In particular, the system environment 100 includes server(s) 104, an issuing system server 106, and a client device 108 in communication via a network 110. Moreover, as shown, the issuing system server 106 hosts at least a portion of an issuing system 112. FIG. 1 also illustrates that the client device includes a banking application 114.

As shown, in FIG. 1, the server(s) 104 include or host the card lifecycle encryption system 102. The server(s) 104 communicate with one or more other components in the system environment 100 to manage card accounts for users. For example, the card lifecycle encryption system 102 communicates with the issuing system 112 to manage card lifecycles of card accounts of users. As used herein, the term “card account” refers to a user's debit card account, credit card account, gift card account, or any other account from which money can be deducted or to which money can be deposited in connection with a card. For example, a user deducts money from or deposits money to a card account for use with a payment card (e.g., a debit card, credit card, or gift card). Additionally, payment card accounts can be associated with physical payment cards or digital versions of payment cards (e.g., within a digital wallet).

In connection with managing card accounts for users, the card lifecycle encryption system 102 also manages card lifecycles of the card accounts. Specifically, payment cards often have an amount of time for which a payment card is usable once the payment card is activated. Accordingly, as used herein, the term “card lifecycle action” refers to operations in connection with initiating, pausing, ending, or otherwise managing a payment card during a lifecycle of the payment card. For instance, card lifecycle actions include setting a PIN for a card account, revealing a PIN for a card account, activating a card associated with a card account, or disabling/deactivating a card associated with a card account. Thus, card lifecycle actions affect an accessibility or status of a card and/or a card account for a user.

In one or more embodiments, the issuing system 112 includes a system that provides card accounts for users. For example, the issuing system 112 includes an issuing bank or other entity that issues and/or manages the funds within a card account. In some embodiments, the issuing system 112 approves or declines transactions involving a card account. The issuing system also operates with the card lifecycle encryption system 102 to provide various card account services including, but not limited to, performing card lifecycle actions, engaging in payment transactions (e.g., peer-to-peer transactions, peer-to-business transactions, installment/buy-now-pay-later purchasing transactions, electronic transactions, point-of-sale transactions), or managing personal and account related information. In additional embodiments, the issuing system 112 communicates with the card lifecycle encryption system 102 and/or other systems within a payment network for processing payment transactions associated with card accounts.

As mentioned, the card lifecycle encryption system 102 communicates with the issuing system 112 to manage card lifecycles for card accounts of users. In one or more embodiments, the issuing system 112 (e.g., via the issuing system server 106) communicates with the client device 108 via the network 110 to perform various operations in connection with a card account of a user associated with the client device 108. In particular, the issuing system 112 provides access to the card account of the user and/or a plurality of tools for managing the card account via the banking application 114 at the client device 108. To illustrate, the issuing system 112 provides detailed information about the card account such as, but not limited to, an account balance and user information for the user. In addition, the issuing system 112 can provide options for performing card lifecycle actions associated with the card account.

In connection with performing card lifecycle actions, the issuing system 112 communicates with the card lifecycle encryption system 102 to provide information associated with requests to perform card lifecycle actions. Specifically, the card lifecycle encryption system 102 receives indications of requests to perform card lifecycle actions for card accounts from the issuing system 112. To illustrate, the card lifecycle encryption system 102 provides one or more application programming interfaces (“APIs”) for the issuing system 112 to interface with the card lifecycle encryption system 102 and provide the information associated with the requests.

Furthermore, the card lifecycle encryption system 102 utilizes one or more APIs to provide encryption and/or authentication tools for encrypting and/or authenticating information in connection with performing the card lifecycle actions. For example, the API(s) include interfacing protocols for systems to integrate with the card lifecycle encryption system 102 (e.g., by integrating software components from the card lifecycle encryption system 102 into applications) and perform various actions associated with account management and card management as defined within the API(s). In one or more embodiments, the issuing system 112 and/or the client device 108 utilize the encryption/authentication information from the card lifecycle encryption system 102 to encrypt and authenticate communications with the card lifecycle encryption system 102. The card lifecycle encryption system 102 also utilizes one or more APIs to validate and decrypt encrypted messages from the issuing system 112. Furthermore, the card lifecycle encryption system 102 performs card lifecycle actions based on requests and then notifies the issuing system 112 and the client device 108 of the results of performing the card lifecycle actions.

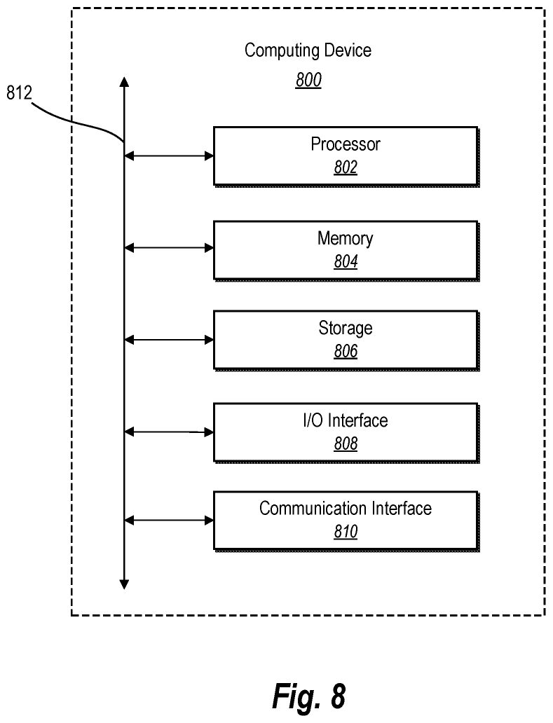

In one or more embodiments, the server(s) 104 include a variety of computing devices, including those described below with reference to FIG. 8. For example, the server(s) 104 includes one or more servers for storing and processing data associated with card lifecycle management. In some embodiments, the server(s) 104 also include a plurality of computing devices in communication with each other, such as in a distributed storage environment. In some embodiments, the server(s) 104 communicate with a plurality of issuing systems and issuing system devices (including the issuing system 112 and the issuing system server 106) based on established relationships between the card lifecycle encryption system 102 and the issuing systems. In additional embodiments, the server(s) 104 communicate with other entities or systems including financial institutions (e.g., issuing banks associated with payment cards), payment card networks associated with processing payment transactions involving payment cards, payment gateways, merchant entities or other systems.

In addition, in one or more embodiments, the issuing system 112 is implemented on one or more issuing system servers. For example, while FIG. 1 illustrates a single issuing system server (i.e., issuing system server 106 including a single server device), the issuing system 112 can be partially or fully implemented on a plurality of issuing system servers. To illustrate, the issuing system 112 can be implemented in a distributed environment. In one or more embodiments, each issuing system server handles requests for one or more card lifecycle actions for a plurality of card accounts of a plurality of users. Additionally, as illustrated, the card lifecycle encryption system 102 communicates with a single issuing system server for performing a single card lifecycle action.

Additionally, as shown in FIG. 1, the system environment 100 includes the network 110. The network 110 enables communication between components of the system environment 100. In one or more embodiments, the network 110 may include the Internet or World Wide Web. Additionally, the network 110 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the issuing system server 106, and the client device 108 communicate via the network 110 using one or more communication platforms and technologies suitable for transporting data and/or communication signals, including any known communication technologies, devices, media, and protocols supportive of data communications, examples of which are described with reference to FIG. 8. Additionally, in one or more embodiments, one or more of the various components of the system environment 100 communicate using protocols for payment card transactions, financial information communications such as payment card industry (“PCI”) standards, or other protocols.

In addition, as shown in FIG. 1, the system environment 100 includes the client device 108. In one or more embodiments, the client device 108 includes, but is not limited to, a mobile device (e.g., smartphone or tablet), a laptop, a desktop, including those explained below with reference to FIG. 8. Furthermore, although not shown in FIG. 1, the client device 108 can be operated by a user (e.g., a user included in, or associated with, the system environment 100) to perform a variety of functions. In particular, the client device 108 performs functions such as, but not limited to, accessing, viewing, and interacting with a card account. In some embodiments, the client device 108 also performs functions for initiating operations for engaging in payment transactions utilizing a card account, managing data associated with the card account, or initiating card lifecycle actions for the card account. For example, the client device 108 communicates with the server(s) 104 via the network 110 to provide information (e.g., user interactions and/or data) associated with managing a card account. Although FIG. 1 illustrates the system environment 100 with a single client device 108, in some embodiments, the system environment 100 includes a different number of client devices.

As described above, in one or more embodiments, the card lifecycle encryption system 102 securely communicates with the issuing system 112 (e.g., the server(s) 104 securely communicate with the issuing system server 106) to perform card lifecycle actions. In particular, the card lifecycle encryption system 102 utilizes double signature validation to verify the identities of the issuing system server 106 and the client device 108 in connection with a request message for performing a card lifecycle action. Additionally, the card lifecycle encryption system 102 utilizes encryption (e.g., envelope encryption involving an encryption key set provided by the card lifecycle encryption system 102) to verify and authenticate the contents of the request message for performing the card lifecycle action. More specifically, the card lifecycle encryption system 102 provides one or more APIs that issuing systems leverage to securely communicate with the card lifecycle encryption system 102 for card lifecycle management via encryption and double signature validation.

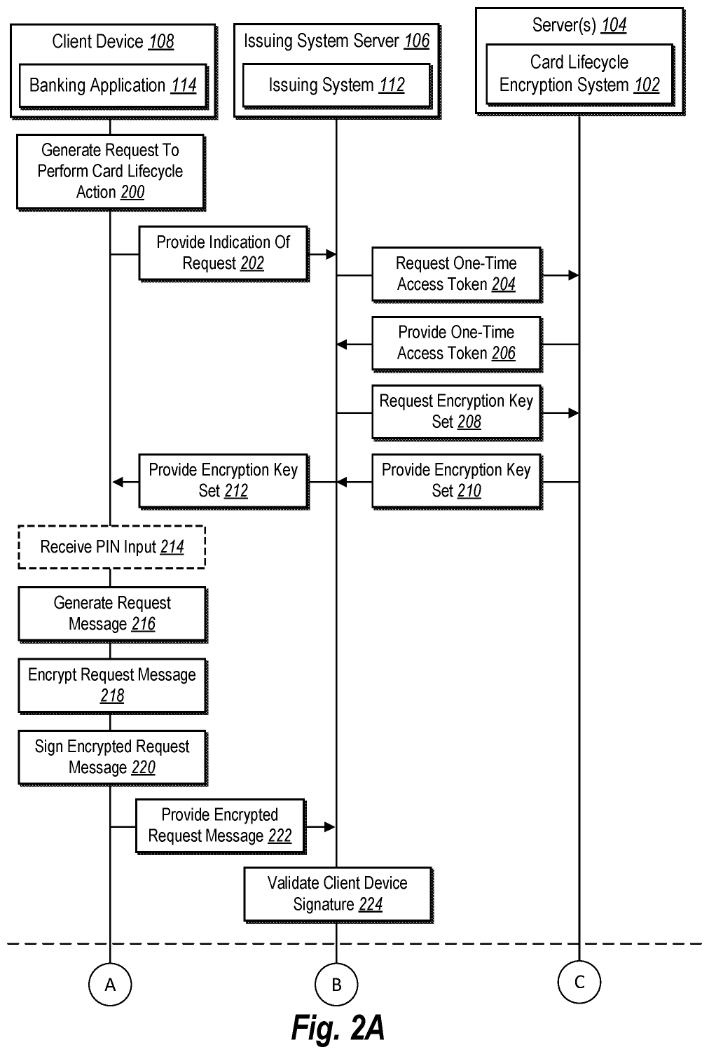

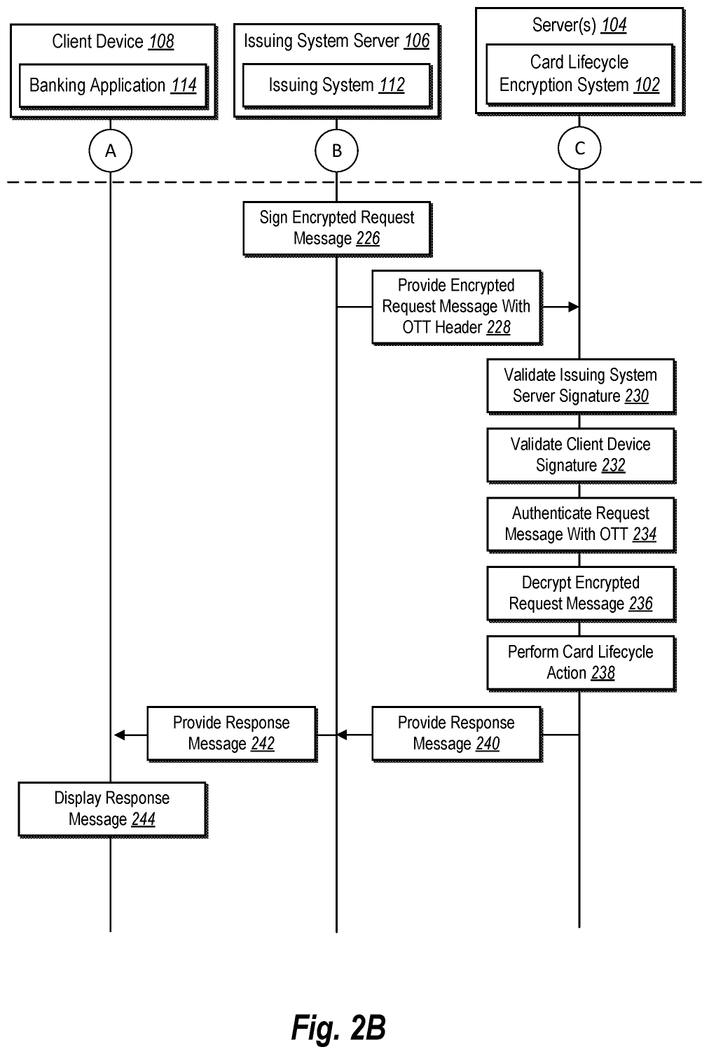

As mentioned, the card lifecycle encryption system 102 provides and utilizes one or more APIs to communicate with an issuing system in connection with requests for performing card lifecycle actions. FIGS. 2A-2B illustrate example process diagrams associated with performing a card lifecycle action for a card account of a user. Specifically, consistent with the system environment 100 of FIG. 1, FIGS. 2A-2B illustrate the server(s) 104, the issuing system server 106, and the client device 108. Furthermore, as illustrated, the server(s) 104 host the card lifecycle encryption system 102, the issuing system server 106 hosts the issuing system 112, and the client device 108 includes the banking application 114.

In one or more embodiments, FIG. 2A illustrates that a process for a user to perform a card lifecycle action for a card account of the user via the card lifecycle encryption system 102 begins with the client device 108 performing an act 200 of generating a request to perform a card lifecycle action. In particular, the client device 108 includes the banking application 114 to provide one or more sets of tools for a user to manage a card account. For example, the banking application 114 includes a standalone (e.g., proprietary) application for a user to communicate with the issuing system 112 and perform actions for viewing information associated with, or otherwise managing, the card account. Alternatively, the banking application 114 includes a web-based application (e.g., a web browser) for a user to access a website associated with the issuing system 112.

According to one or more embodiments, the banking application 114 provides tools for a user to view information associated with a card account and perform card lifecycle actions associated with the card account. For instance, the client device 108 displays tools within one or more graphical user interfaces of the banking application 114 to request that the issuing system 112 and/or the card lifecycle encryption system 102 perform a card lifecycle action for the card account. To illustrate, the client device 108 displays one or more options to set a PIN for the card account, reveal a PIN established for the card account, activate a payment card for the card account, or disable a payment card for the card account. In response to an interaction by the user with an option to perform a card lifecycle action for the card account, the client device 108 generates the request to perform the selected lifecycle action.

In one or more embodiments, as illustrated in FIG. 2A, the client device 108 performs an act 202 of providing an indication of the request to the issuing system 112 at the issuing system server 106. In particular, the client device 108 can provide a message to the issuing system 112 (e.g., via the banking application 114) of the card lifecycle action. In some instances, the client device 108 provides the indication of the card lifecycle action to the issuing system 112 as part of the request to perform the card lifecycle action. Alternatively, the client device 108 provides the indication of the card lifecycle action in advance of providing the request of the card lifecycle action to the issuing system 112.

According to one or more embodiments, in response to receiving an indication of a request to perform a card lifecycle action for a card account, the issuing system 112 communicates with the card lifecycle encryption system 102 to request an authentication token for use in communicating with the card lifecycle encryption system 102. As illustrated in FIG. 2A, the issuing system 112 performs an act 204 of requesting a one-time access token for use in authenticating messages with the card lifecycle encryption system 102. In one or more embodiments, the issuing system 112 generates a hypertext transfer protocol (“HTTP”) message such as a POST request message for the one-time access token from the card lifecycle encryption system 102. To illustrate, the issuing system server 106 sends the request message via an API provided by the card lifecycle encryption system 102 for managing card accounts including, but not limited to, protocols for authenticating communications, obtaining tokens in connection with card accounts, authorizing transactions associated with card accounts, and establishing various configurations for card accounts.

In response to the request message for the one-time access token, the card lifecycle encryption system 102 obtains the one-time access token. For instance, the card lifecycle encryption system 102 obtains the one-time access token from a third-party system that generates the one-time access token. To illustrate, the card lifecycle encryption system 102 generates a request message (e.g., a POST request message) to send to the third-party system via an API of the third-party system. The card lifecycle encryption system 102 then receives the one-time access token from the third-party system. In alternative embodiments, the card lifecycle encryption system 102 generates the one-time access token.

As illustrated in FIG. 2A, after obtaining a one-time access token based on the request from the issuing system 112, the card lifecycle encryption system 102 performs an act 206 of providing the one-time access token to the issuing system 112. Specifically, the server(s) 104 communicates with the issuing system server 106 to provide the one-time access token to the issuing system 112 in response to the request for the token. By providing the one-time access token to the issuing system 112 in connection with performing a card lifecycle action, the card lifecycle encryption system 102 ensures that the issuing system is able to communicate with the card lifecycle encryption system 102 a single time using the one-time access token in connection with the card lifecycle action.

In addition to requesting a one-time access token from the card lifecycle encryption system 102, in one or more embodiments, the issuing system 112 also requests encryption tools from the card lifecycle encryption system 102. For example, as illustrated in FIG. 2A, the issuing system server 106 performs an act 208 of requesting an encryption key set from the card lifecycle encryption system 102. In particular, the issuing system 112 generates an HTTP message (e.g., a GET request message) to send to the card lifecycle encryption system 102 requesting an encryption key set from the card lifecycle encryption system 102.

According to one or more embodiments, the encryption key set includes a plurality of public keys maintained by the card lifecycle encryption system 102 for encrypting data. Additionally, in some embodiments, the encryption key set also provides the ability for devices to sign tokens For example, the encryption key set can be associated with a particular signing algorithm for verifying keys in the encryption key set. In one or more embodiments, the encryption key set includes a JSON Web Key Set including public keys signed utilizing a particular signature algorithm for authenticating the keys in the encryption key set.

As illustrated in FIG. 2A, in response to the request for the encryption key set, the card lifecycle encryption system 102 performs an act 210 of providing the encryption key set to the issuing system 112. Specifically, the server(s) 104 provide the encryption key set (e.g., stored by an endpoint of the card lifecycle encryption system 102) to the issuing system server 106 for access by the issuing system 112. Additionally, in one or more embodiments, as illustrated in FIG. 2A, the issuing system 112 performs an act 212 of providing the encryption key set to the client device 108. In particular, the issuing system server 106 forwards the encryption key set received from the server(s) 104 to the client device 108 for access by the banking application 114.

After receiving the encryption key set from the issuing system 112, the client device 108 utilizes the encryption key set to initiate the request to perform a card lifecycle action. For example, if the card lifecycle action includes setting a PIN for a card account, the client device 108 determines a PIN to provide to the card lifecycle encryption system 102. As illustrated in FIG. 2A, the client device 108 optionally performs an act 214 of receiving a PIN input within a graphical user interface of the banking application 114 via an input device (e.g., a touchscreen). To illustrate, a user of the client device 108 interacts with a graphical user interface of the banking application 114 to enter a PIN for the card account.

As illustrated in FIG. 2A, the client device 108 performs an act 216 of generating a request message in connection with performing the card lifecycle action. Specifically, the client device generates a request message including information associated with performing the card lifecycle action. For instance, the card lifecycle encryption system 102 generates the request message to include a card token representing the card account (e.g., an account number). Additionally, the request message can include, but is not limited to, a client identifier representing the client device 108, and a user token representing an identity of the user.

Furthermore, the request message can include different information depending on the type of card lifecycle action being requested. For example, if the card lifecycle action includes an action to set a PIN for the card account, the request message also includes the received PIN. Alternatively, if the card lifecycle action includes an action to reveal a PIN already established for the card account, the request message includes an PIN reveal request. If the card lifecycle action includes an action to activate a card ready to be activated for the card account, the request message includes a request to activate the card. Furthermore, if the card lifecycle action includes an action to disable/deactivate a card for the card account, the request message includes a request to disable/deactivate the card.

As FIG. 2A illustrates, after generating the request message, the card lifecycle encryption system 102 performs an act 218 of encrypting the request message. Specifically, the client device 108 utilizes the encryption key set provided by the card lifecycle encryption system 102 to encrypt the request message. In one or more embodiments, the client device 108 first generates a symmetric data encryption key to encrypt the request message. The client device 108 can then encrypt the symmetric data encryption key utilizing a public key obtained from the encryption key set to generate the encrypted request message and encrypted key (e.g., within an encrypted payload for the card lifecycle action). Accordingly, in some embodiments, the client device 108 utilizes envelope encryption to encrypt the request message along with the symmetric data encryption key utilized to encrypt the request message.

In one or more embodiments, the client device 108 provides additional authentication for the encrypted request message. In particular, as illustrated in FIG. 2A, the client device 108 performs an act 220 of signing the encrypted request message. For example, the client device 108 signs the encrypted request message according to a signature protocol associated with, or otherwise compatible with, the encrypted request message. To illustrate, the client device 108 utilizes a private key in a private-public key pair associated with the client device 108 to sign the encrypted request message, thus verifying the identity of the client device 108. FIG. 2A further illustrates that the client device 108 then performs an act 222 of providing the encrypted request message to the issuing system 112 (e.g., to the issuing system server 106).

FIG. 2A illustrates that, upon receiving the encrypted request message from the client device 108, the issuing system 112 performs an act 224 of validating the client device signature. For example, the issuing system 112 utilizes a public key from the private-public key pair that the client device 108 utilized to sign the encrypted request message to validate the client device signature. By validating that the signature of the encrypted request message corresponds to the client device 108, the issuing system 112 can also verify that the client device 108 sent the encrypted request message to the issuing system 112.

As mentioned, in connection with a request to perform a card lifecycle action associated with a card account, the card lifecycle encryption system 102 provided an encryption key set (with a public key) to the issuing system 112. Because the issuing system 112 received only the encryption key set from the card lifecycle encryption system 102, the issuing system 112 is not able to access/decrypt the data in the encrypted request message. Accordingly, the issuing system 112 only validates the client device signature of the encrypted request message (e.g., using the public key in the private-public key pair used to sign the encrypted request message).

In one or more embodiments, the issuing system 112 also provides additional authentication for the encrypted request message. Specifically, as illustrated in FIG. 2B, the issuing system server 106 performs an act 226 of signing the encrypted request message received from the client device 108. For instance, the issuing system server 106 signs the encrypted request message according to a signature protocol associated with, or otherwise compatible with, the encrypted request message. To illustrate, the issuing system server 106 utilizes a private key in a private-public key pair associated with the issuing system server 106 to sign the encrypted request message a second time to also verify the identity of the issuing system server 106 with the encrypted request message.

FIG. 2B also illustrates that the issuing system 112 performs an act 228 of providing the encrypted request message with a one-time access token header (“OTT header”) to the card lifecycle encryption system 102. More specifically, the issuing system server 106 provides the encrypted request message to the card lifecycle encryption system 102. In one or more embodiments, in addition to providing the encrypted request message, the issuing system 112 also includes the previously received one-time access token with the encrypted request message. For example, the issuing system 112 generates the OTT header including the one-time access token to forward the encrypted request message to the card lifecycle encryption system 102. By including the one-time access token with the encrypted request message, the issuing system 112 authenticates the communication with the card lifecycle encryption system 102 based on previously receiving the one-time access token from the card lifecycle encryption system 102.

In one or more embodiments, the issuing system 112 sends the encrypted request message to the card lifecycle encryption system 102 by leveraging the API provided by the card lifecycle encryption system 102. For instance, the issuing system 112 utilizes a set of API calls for performing specific card lifecycle actions. To illustrate, the issuing system 112 generates a POST request message including the encrypted request message and the OTT header by utilizing an API call that routes the message to a particular software or hardware component. In one or more embodiments, for a card lifecycle action including setting or revealing a PIN for a card account, the issuing system 112 utilizes API calls for accessing or modifying a PIN of the card account. In one or more embodiments, for a card lifecycle action including activating or disabling a card of the card account, the issuing system 112 utilizes API calls corresponding to card information for the card account.

Upon receiving an encrypted request message from the issuing system 112 (e.g., from the issuing system server 106), the card lifecycle encryption system 102 performs a number of operations to authenticate the encrypted request message. Specifically, as illustrated in FIG. 2B, the card lifecycle encryption system 102 performs an act 230 of validating a signature of the issuing system server 106. For instance, the card lifecycle encryption system 102 can utilize a public key from a private-public key pair associated with the issuing system server 106 to validate the signature of the issuing system server 106. In particular, by validating the signature of the issuing system server 106 on the encrypted request message, the card lifecycle encryption system 102 is able to determine that the issuing system server 106 sent the encrypted request message.

Furthermore, as illustrated in FIG. 2B, the card lifecycle encryption system 102 also performs an act 232 of validating a signature of the client device 108. In particular, the card lifecycle encryption system 102 can utilize a public key from a private-public key pair associated with the client device 108 to validate the signature of the client device 108. By validating the signature of the client device 108 on the encrypted request message, the card lifecycle encryption system 102 can determine that the client device 108 generated/originated the encrypted request message. Additionally, validating the signatures of the client device 108 and the issuing system server 106 on the encrypted request message ensures that the encrypted request message is sent from the client device 108 and forwarded by the issuing system server 106. More specifically, validating the signatures verifies that another device or system did not send a message to the card lifecycle encryption system 102 in an attack on the card lifecycle encryption system 102.

According to one or more embodiments, after validating the signatures on the encrypted request message, the card lifecycle encryption system 102 also authenticates the client device 108. For example, as illustrated in FIG. 2B, the card lifecycle encryption system 102 performs an act 234 of authenticating the request message with the OTT header. Specifically, the card lifecycle encryption system 102 utilizes the OTT header of the encrypted request message to authenticate the client device 108 with the one-time access token.

To illustrate, the card lifecycle encryption system 102 utilizes a first API layer (e.g., associated with performing card lifecycle actions) to generate a POST request message including the one-time access token and an application token associated with the issuing system 112 and/or the banking application 114 in a header of the POST request message with an empty request body. The card lifecycle encryption system 102 then passes the POST request message to a second API layer (e.g., associated with managing card accounts) to authenticate the client device 108. In response to the POST request message, the card lifecycle encryption system 102 utilizes the second API layer to provide an access token to the first API layer. In some embodiments, the access token has a time limit for which the access token is usable.

In one or more embodiments, the card lifecycle encryption system 102 accesses the contents of the encrypted request message. As illustrated in FIG. 2B, the card lifecycle encryption system 102 performs an act 236 of decrypting the encrypted request message. For instance, the card lifecycle encryption system 102 utilizes an encryption key associated with the public key that encrypted the symmetric data encryption key at the client device to first decrypt the symmetric data encryption key. The card lifecycle encryption system 102 then utilizes the symmetric data encryption key to decrypt the encrypted request message and access the contents of the request message. As previously indicated, the request message can include information that the card lifecycle encryption system 102 utilizes to perform a particular card lifecycle action for a card account.

In one or more embodiments, as illustrated in FIG. 2B, the card lifecycle encryption system 102 performs an act 238 of performing the card lifecycle action. Specifically, the card lifecycle encryption system 102 utilizes the data accessed from the request message to perform the card lifecycle action. In additional embodiments, the card lifecycle encryption system 102 utilizes the access token received in connection with authenticating the client device 108 with the one-time access token to perform the card lifecycle action. For example, the card lifecycle encryption system 102 generates (e.g., via a first API layer) a request message (e.g., a POST request message) including the previously received application token as a username and the access token as a password in a header and a card token from the request message in a request body for authenticating with a controller endpoint (e.g., at a second API layer) of the card lifecycle encryption system 102. In one or more embodiments, the controller endpoint returns control token that authorizes the card lifecycle encryption system 102 to perform the card lifecycle action for the card account.

Additionally, the card lifecycle encryption system 102 can then perform the card lifecycle action according to the specific action type. For instance, if the card lifecycle action includes setting a PIN for the card account, the card lifecycle encryption system 102 generates a message (e.g., a PUT request message via the first API layer) including the control token with a PIN number. The card lifecycle encryption system 102 then sets the PIN for the card account (e.g., via the second API layer) according to the received PIN in the request message. In alternative embodiments involving other types of card lifecycle actions (e.g., PIN reveal, card activation, card disabling), the card lifecycle encryption system 102 utilizes the corresponding API calls with the control token to perform the various card lifecycle actions.

As illustrated in FIG. 2B, after performing the card lifecycle action based on the request message, the card lifecycle encryption system 102, the card lifecycle encryption system 102 performs an act 240 of providing a response message to the issuing system 112. Specifically, the card lifecycle encryption system 102 generates a status code in response to performing the card lifecycle action. In one or more embodiments, each card lifecycle action is associated with a specific status code. Additionally, the status code can indicate whether the card lifecycle encryption system 102 successfully performed the card lifecycle action. The card lifecycle encryption system 102 can then include the status code in the response message.

In one or more embodiments, the card lifecycle encryption system 102 also generates and/or provides additional information within a response message. For instance, in response to performing a card lifecycle action of revealing a PIN associated with a card account, the card lifecycle encryption system 102 includes the PIN for the card account within the response message. If the response message includes a PIN or other sensitive information, the card lifecycle encryption system 102 can encrypt (and in some instances sign) the response message for securely communicating the information to the client device 108. Additionally, to prevent the issuing system 112 from having access to the contents of the response message, the card lifecycle encryption system 102 can utilize an encryption key to which the issuing system 112 does not have access (e.g., via a private-public key pair associated with the client device 108 or utilizing envelope encryption).

FIG. 2B further illustrates that the issuing system 112 performs an act 242 of providing the response message to the client device 108. To illustrate, in response to receiving the response message from the card lifecycle encryption system 102 including the status code based on performing the card lifecycle action, the issuing system 112 forwards the response message to the client device 108 based on the request message. Specifically, the card lifecycle encryption system 102 and the issuing system 112 return the response message to the calling service at the client device 108 (e.g., to the banking application 114 via which the client device 108 initially issued the request to perform the card lifecycle action).

As illustrated in FIG. 2B, upon receiving the response message from the issuing system 112, the client device 108 performs an act 244 of displaying a response message. In particular, the client device 108 determines a response message to display based on the status code in the response message received from the issuing system 112. For example, if the status code indicates that the card lifecycle encryption system 102 successfully set a PIN for the card account associated with a user of the client device 108, the client device 108 can display a response message indicating that the PIN was changed (e.g., within a graphical user interface of the banking application 114). Alternatively, if the status code indicates successful or failed performance of a particular card lifecycle action, the client device 108 can display the corresponding response message. If the response message indicates a failed action, the client device 108 can indicate a reason for failure (e.g., communication error, unauthorized access, invalid signature, weak PIN, server error) and/or request that the user initiate the attempt to perform the action.

Additionally, if the response message is encrypted or includes one or more encrypted portions, the client device 108 can decrypt the encrypted data/portions. To illustrate, in response to the card lifecycle encryption system 102 performing a card lifecycle action to reveal a PIN associated with card account of a user of the client device 108, the client device 108 can receive the PIN in a response message that has been encrypted. The client device 108 can then verify the authenticity of the response message and decrypt the response message utilizing one or more decryption methods according to the encryption method for the response message.

In one or more embodiments, the card lifecycle encryption system 102 utilizes one or more APIs to ensure the security of communications between the issuing system 112 and the card lifecycle encryption system 102. In additional embodiments, the card lifecycle encryption system 102 and/or the issuing system 112 ensures (e.g., via the banking application 114) the security of the card lifecycle action at the client device 108. For example, the card lifecycle encryption system 102 or the issuing system 112 can leverage the banking application 114 to verify that the client device 108 does not retain sensitive information associated with the card lifecycle action. To illustrate, the card lifecycle encryption system 102 or the issuing system 112 can ensure that a PIN and/or other information associated with the card account is not retained in memory on the client device 108 or communicated to any other devices. Additionally, the card lifecycle encryption system 102 or the issuing system 112 can encrypt PIN data displayed or entered into a graphical user interface to prevent an entire decrypted PIN from being stored in device memory.

In additional embodiments, the card lifecycle encryption system 102 provides additional security for communications involving the issuing system 112 and/or client devices for card lifecycle management. For example, card lifecycle encryption system 102 can utilizes key rotation to continually update encryption key pairs retained by client devices and revoke access to old encryption key pairs at the client devices. Additionally, the card lifecycle encryption system 102 can communicate with issuing systems to provide initial encryption keys via configuration updates for applications on devices (e.g., over-the-air application updates on mobile devices).

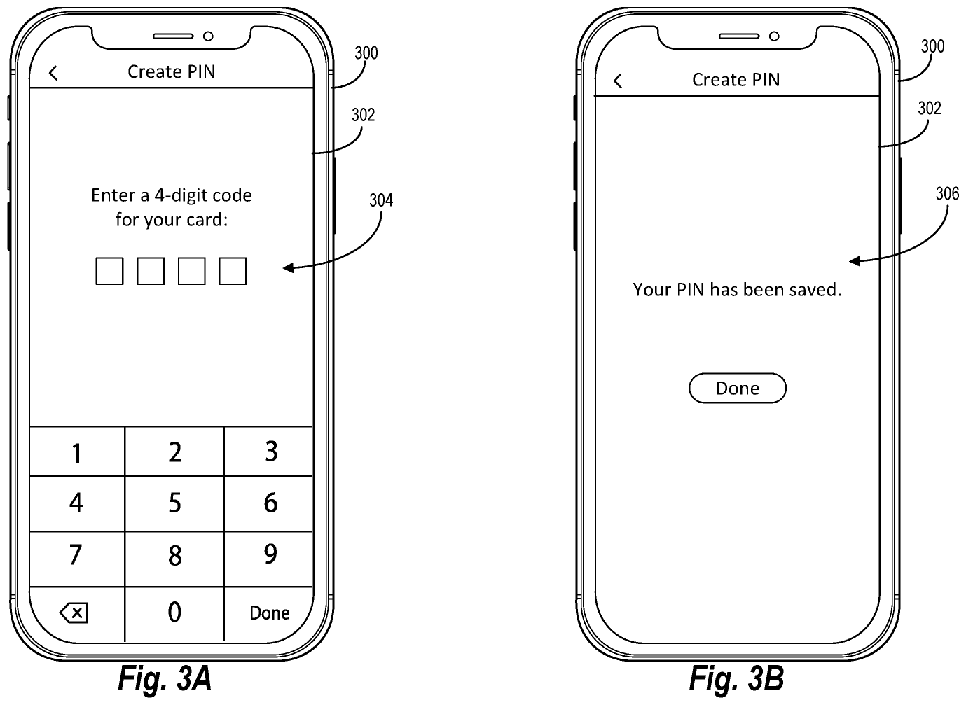

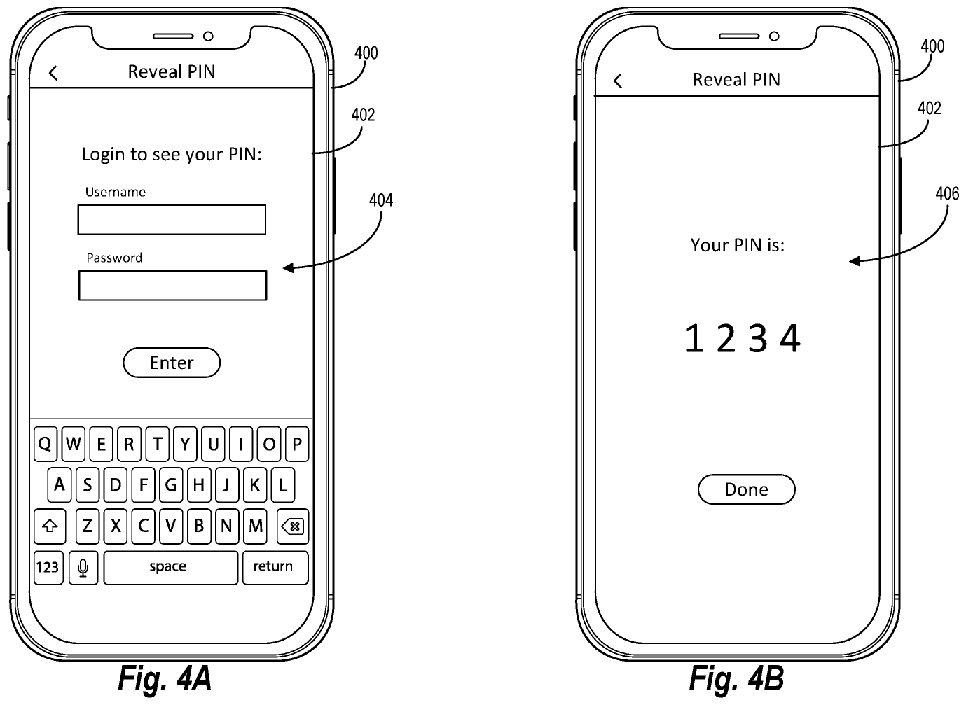

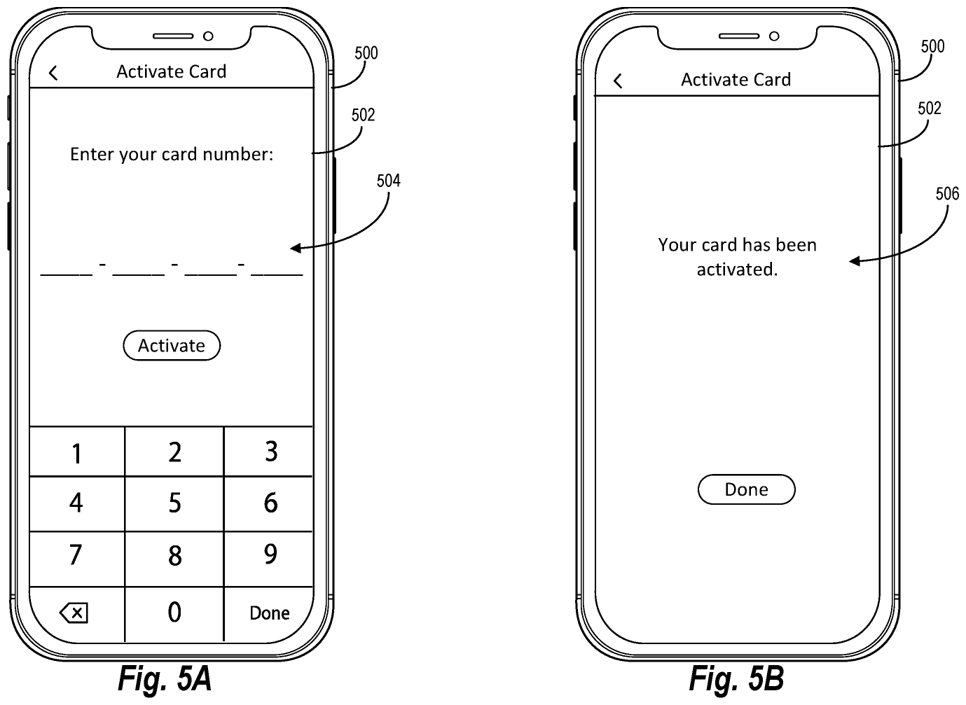

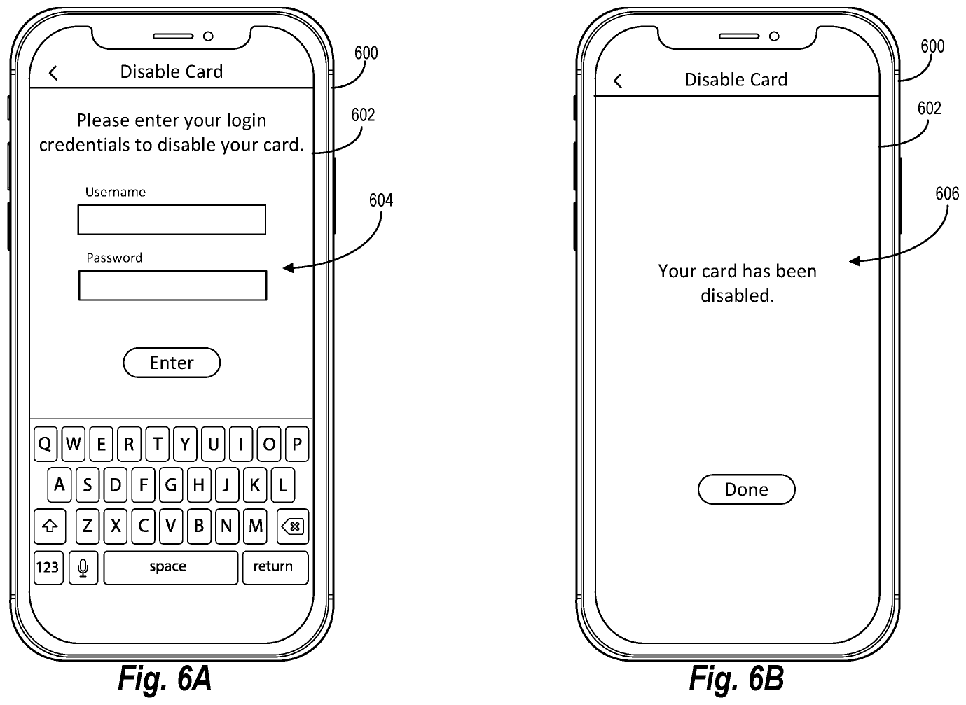

As mentioned, the card lifecycle encryption system 102 can provide secure communications for a plurality of card lifecycle actions. In one or more embodiments, the card lifecycle actions include setting a PIN of a card account, revealing a PIN of a card account, activating a card of a card account, and disabling a card of a card account. FIGS. 3A-3B illustrate graphical user interfaces for setting a PIN of a card account. FIGS. 4A-4B illustrate graphical user interfaces for revealing a PIN of a card account. FIGS. 5A-5B illustrate graphical user interfaces for activating a card of a card account. FIGS. 6A-6B illustrate graphical user interfaces for disabling a card of a card account.

FIG. 3A illustrates a client device 300 displaying a graphical user interface of a client application 302. For example, the client application 302 includes a banking application or a card account management application that includes a plurality of tools for accessing, viewing, and otherwise managing a card account of a user. In one or more embodiments, the client device 300 provides one or more tools for performing card lifecycle actions associated with the card account. More specifically, the client device 300 can display various graphical user interfaces of the client application 302 for requesting that the card lifecycle encryption system 102 perform one or more card lifecycle actions.

In one or more embodiments, as mentioned, the card lifecycle encryption system 102 provides an API for an issuing system associated with the client application 302 to use in integrating the client application 302 with the card lifecycle encryption system 102. The issuing system can thus integrate with the card lifecycle encryption system 102 to include one or more software components in the client application 302 for performing card lifecycle actions. Accordingly, the client device 300 utilizes encryption and signing for securely communicating with the issuing system and the card lifecycle encryption system 102 (via the issuing system) based on the API provided by the card lifecycle encryption system 102.

For example, FIG. 3A illustrates that the client device 300 displays a PIN setting interface 304 in which a user of the client device 300 can enter a PIN for a card account of the user. In particular, the client device 300 can display the PIN setting interface 304 in response to a request by the user (e.g., via an interaction with the client device 300 via the client application 302) to set the PIN for the card account. To illustrate, the client device 300 can detect inputs to enter a numerical code (e.g., a four-digit code) representing the PIN of the card account. In one or more embodiments, as the user enters the PIN into the client device 300, the client device 300 encrypts PIN data for sending to the card lifecycle encryption system 102 in connection with performing the card lifecycle action to set the PIN for the card account.

After receiving the PIN, the client device 300 encrypts the PIN utilizing an encryption key from the card lifecycle encryption system 102. Additionally, the client device 300 signs the encrypted PIN and provides the encrypted and signed PIN to the issuing system. Furthermore, as described above, the issuing system validates the signature of the client device 300 and also signs the encrypted PIN to send to the card lifecycle encryption system. The card lifecycle encryption system 102 validates the signatures of the client device 300 and the issuing system, decrypts the PIN, and then sets the PIN for the card account of the user of the client device 300.

Additionally, as mentioned, in response to performing the card lifecycle action to set the PIN for the card account, the card lifecycle encryption system 102 generates a response message with a status code. In particular, in response to successfully setting the PIN for the card account, the card lifecycle encryption system 102 generates a response message including a status code indicating that the action was successful. The card lifecycle encryption system 102 then provides the status code to the client device 300. FIG. 3B illustrates that the client device 300 displays a response message 306 based on the status code indicating that the card lifecycle encryption system 102 successfully set the PIN for the card account.

In addition to setting a PIN of a card account, the card lifecycle encryption system 102 can also perform a card lifecycle action to reveal a PIN for a card account. For example, FIG. 4A illustrates a client device 400 displaying a graphical user interface of a client application 402. Specifically, the client device 400 displays a PIN reveal interface 404 in response to a request (e.g., via an interaction with the client device 400 via the client application 402) to obtain and display a PIN stored for a card account of a user. In one or more embodiments, the PIN reveal interface 404 includes a request by the user to authenticate with an issuing system by entering a username and a password (or otherwise provide credentials such as biometric authentication) into the PIN reveal interface 404.

In connection with the PIN reveal request and authenticating with the issuing system, the client device 400 encrypts a request message for providing to the card lifecycle encryption system 102 including data associated with the card lifecycle action. For instance, the client device 400 can generate the encrypted message to include a code or other indicator of the PIN reveal request. The client device 400 can encrypt and sign the request message to provide to the issuing system. Additionally, after validating the signature of the client device 400, the issuing system also signs the encrypted request message to provide to the card lifecycle encryption system 102.

Upon receiving the encrypted request from the issuing system, in one or more embodiments, the card lifecycle encryption system 102 validates the signatures of the issuing system and the client device 400. The card lifecycle encryption system 102 then decrypts the request message and utilizes the data in the request message to perform the corresponding card lifecycle action of revealing a PIN for a card account. Specifically, the card lifecycle encryption system 102 accesses the PIN stored for the card account and returns the PIN in an encrypted message to the client device 400 (e.g., in addition to a status code). As illustrated in FIG. 4B, the client device 400 then displays a response message 406 including the PIN within a graphical user interface of the client application 402.

In one or more additional embodiments, the card lifecycle encryption system 102 provides a card lifecycle action for activating a card of a card account. Specifically, FIG. 5A illustrates a client device 500 displaying a graphical user interface of a client application 502. For instance, the client device 500 displays a card activation interface 504 in response to a request (e.g., via an interaction with the client device 500 via the client application 502) to activate a card associated with a card account of a user. To illustrate, the card lifecycle encryption system 102 provides a field for entering a card number (e.g., a credit card number or a debit card number) associated with the card account.

After receiving a card number via the graphical user interface of the client application 502, the client device 500 encrypts the card number utilizing an encryption key from the card lifecycle encryption system 102 and signs the encrypted card number. In one or more alternative embodiments, the client device 500 has a previously stored token representation of the card number (e.g., a card account number). The client device 500 can thus use the previously stored token for the request message and sign the stored token (e.g., with other information within the request message) to send to the issuing system. After validating the client device signature and signing the encrypted request message, the issuing system provides the encrypted request message to the card lifecycle encryption system 102 for signature validation and decryption. The card lifecycle encryption system 102 also performs the card lifecycle action of activating the card based on the request message.

In response to performing the card lifecycle action to activate the card for the card account, the card lifecycle encryption system 102 generates a response message with a corresponding status code. Specifically, the card lifecycle encryption system 102 generates a response message including a status code indicating that the card lifecycle encryption system 102 successfully activated the card. The card lifecycle encryption system 102 also provides the response message with the status code to the client device 500. FIG. 5B illustrates that the client device 500 displays a response message 506 based on the status code indicating that the card lifecycle encryption system 102 successfully activated the card for the card account.

According to one or more embodiments, the card lifecycle encryption system 102 provides a card lifecycle action for disabling a card of a card account. In particular, FIG. 6A illustrates a client device 600 displaying a graphical user interface of a client application 602. For example, the client device 600 displays a card disabling interface 604 in response to a request (e.g., via an interaction with the client device 600 via the client application 602) to disable a card associated with a card account of a user. More specifically, the card lifecycle encryption system 102 provides a request for authenticating with an issuing system by entering a username and a password (or otherwise provide credentials such as biometric authentication) into the card disabling interface 604.

In response to authenticating the user with the issuing system, the client device 600 encrypts a request message indicating the card lifecycle action of disabling a card. For instance, the client device 600 encrypts a request message including a token representing the card (e.g., a token representing the card number) and signs the encrypted request message. To illustrate, the client device 600 utilizes a previously stored token or requests that the user enter the card number for encrypting within the request message. The client device 600 provides the encrypted request message to the issuing system to validate the signature of the client device 600 and also sign before providing the encrypted message to the card lifecycle encryption system 102. Additionally, the card lifecycle encryption system 102 validates the signatures of the issuing system and the client device 600 before decrypting the request message and disabling the card indicated in the request message.

Based on performing the card lifecycle action to disable the card for the card account, the card lifecycle encryption system 102 generates a response message with a status code corresponding to the card lifecycle action. In particular, the card lifecycle encryption system 102 generates a response message including a status code indicating that the card lifecycle encryption system 102 successfully disabled the card. The card lifecycle encryption system 102 then sends the response message with the status code to the client device 600. FIG. 6B illustrates that the client device 600 displays a response message 606 based on the status code indicating that the card lifecycle encryption system 102 successfully disabled the card for the card account.

Although the above figures illustrate various embodiments of graphical user interfaces of client applications displayed on client devices, client devices can utilize other configurations and workflows for performing card lifecycle actions. To illustrate, the card lifecycle encryption system 102 or an issuing system can require that users authenticate (e.g., enter credentials) in connection with performing any card lifecycle action. Additionally, in some embodiments, the card lifecycle encryption system 102 or an issuing system can provide, via a client application, interfaces for selecting from a plurality of different cards to perform card lifecycle actions for a card account.

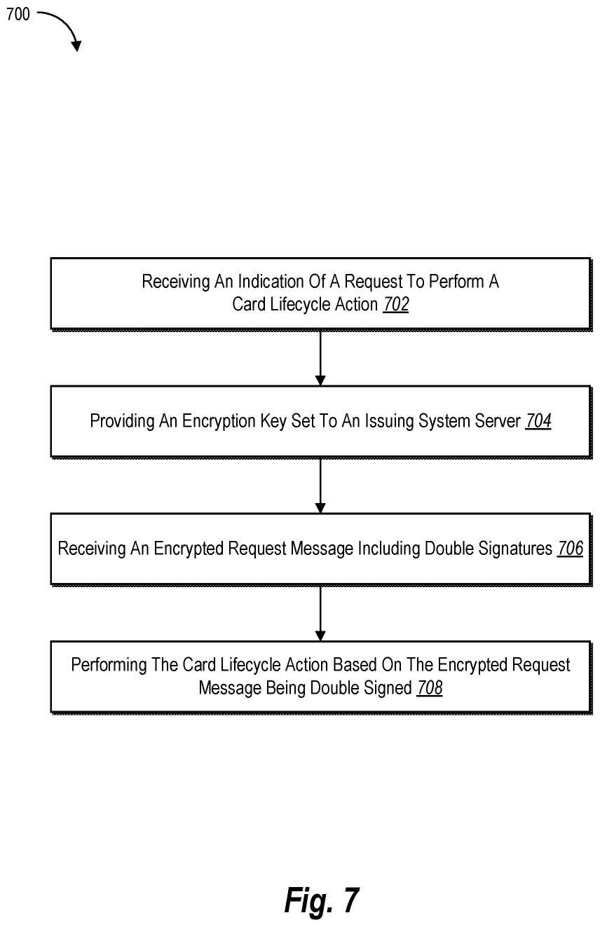

Turning now to FIG. 7, this figure shows a flowchart of a series of acts 700 of utilizing encryption and double signature validation of communications in connection with performing card lifecycle actions for card accounts. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7.

As shown, the series of acts 700 includes an act 702 of receiving an indication of a request to perform a card lifecycle action. For example, act 702 involves receiving, from a issuing system server, an indication of a request to perform a card lifecycle action in connection with a card account of a user.

Act 702 can involve receiving an indication of a request to set a personal identification number associated with the card account of the user via a banking application on the client device of the user. Act 702 can alternatively involve receiving an indication of a request to activate a payment card associated with the card account of the user. Act 702 can involve receiving an indication of a request to disable a payment card associated with the card account of the user. Additionally, act 702 can involve receiving an indication of a request to view a personal identification number associated with the card account of the user via a banking application on the client device of the user.

Act 702 can also involve receiving, from the issuing system server, a token request for a one-time access token based on the indication of the request. Act 702 can further involve providing the one-time access token to the issuing system server in response to the token request.

The series of acts 700 also includes an act 704 of providing an encryption key set to an issuing system server. For example, act 704 involves providing, based on the indication of the request, an encryption key set to the issuing system server.

Additionally, the series of acts 700 includes an act 706 of receiving an encrypted request message including double signatures. For example, act 706 involves receiving, from the issuing system server, an encrypted request message signed by the issuing system server and a client device of the user, the encrypted request message encrypted via the encryption key set and comprising data associated with the request to perform the card lifecycle action.

Act 706 can involve validating that a server signature for the encrypted request message corresponds to the issuing system server. Act 706 can also involve validating that a client device signature for the encrypted request message corresponds to the client device of the user. Act 706 can further involve verifying that a header associated with the encrypted request message comprises the one-time access token.

The series of acts 700 further includes an act 708 of performing the card lifecycle action based on the encrypted request message being double signed. For example, act 708 involves performing the card lifecycle action based on the encrypted request message being signed by the issuing system server and the client device of the user. Act 708 can involve setting a personal identification number associated with the card account of the user based on the data in the encrypted request message.

Act 708 can involve decrypting the encrypted request message to determine the data associated with the request to perform the card lifecycle action. For example, act 708 can involve decrypting the encrypted request message in response to verifying that a header associated with the encrypted request message received from the issuing system server comprises a one-time access token provided to the issuing system server in response to receiving the indication of the request to perform the card lifecycle action. Additionally, act 708 can involve accessing the data associated with the request to perform the card lifecycle action after decrypting the encrypted request message, the data comprising a client identifier of the client device, a user token associated with the user, a card token associated with the card account, and the card lifecycle action. Act 708 can then involve performing the card lifecycle action according to the data associated with the request to perform the card lifecycle action.

The series of acts 700 can also include generating a status code in response to performing the card lifecycle action. The series of acts 700 can then include generating a response message comprising the status code associated with performing the card lifecycle action. The series of acts 700 can then include providing the response message comprising the status code to the issuing system server for display at the client device of the user. In one or more embodiments, the response message causes the client device to display a response message at the client device of the user according to the status code.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the system(s) of FIG. 1. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving, by one or more servers from a issuing system server, an indication of a request to perform a card lifecycle action in connection with a card account of a user;
providing, by the one or more servers based on the indication of the request, an encryption key set to the issuing system server;
receiving, by the one or more servers from the issuing system server, an encrypted request message signed by the issuing system server and a client device of the user, the encrypted request message encrypted via the encryption key set and comprising data associated with the request to perform the card lifecycle action; and
performing, by the one or more servers, the card lifecycle action based on the encrypted request message being signed by the issuing system server and the client device of the user.

2. The computer-implemented method as recited in claim 1, wherein receiving the indication of the request to perform the card lifecycle action further comprises receiving an indication of a request to set a personal identification number associated with the card account of the user via a banking application on the client device of the user.

3. The computer-implemented method as recited in claim 1, wherein receiving the indication of the request to perform the card lifecycle action further comprises receiving an indication of a request to activate a payment card associated with the card account of the user.

4. The computer-implemented method as recited in claim 1, wherein receiving the indication of the request to perform the card lifecycle action further comprises receiving an indication of a request to disable a payment card associated with the card account of the user.

5. The computer-implemented method as recited in claim 1, wherein receiving the indication of the request to perform the card lifecycle action further comprises receiving an indication of a request to view a personal identification number associated with the card account of the user via a banking application on the client device of the user.

6. The computer-implemented method as recited in claim 1, wherein receiving the indication of the request further comprises:
receiving, from the issuing system server, a token request for a one-time access token;
providing the one-time access token to the issuing system server in response to the token request; and
receiving the indication of the request to perform the card lifecycle action after providing the one-time access token to the issuing system server.

7. The computer-implemented method as recited in claim 6, further comprising verifying that a header associated with the encrypted request message comprises the one-time access token.

8. The computer-implemented method as recited in claim 1, wherein receiving the encrypted request message further comprises:
validating that a server signature for the encrypted request message corresponds to the issuing system server; and
validating that a client device signature for the encrypted request message corresponds to the client device of the user.

9. The computer-implemented method as recited in claim 1, wherein performing the card lifecycle action further comprises:
decrypting the encrypted request message to determine the data associated with the request to perform the card lifecycle action; and
performing the card lifecycle action according to the data associated with the request to perform the card lifecycle action.

10. The computer-implemented method as recited in claim 1, wherein further comprising:
generating a response message comprising a status code associated with performing the card lifecycle action; and
providing the response message to the issuing system server for display at the client device of the user.

11. A system comprising:
at least one processor; and
at least one non-transitory computer readable storage medium comprising instructions that, when executed by the at least one processor, cause the system to:
receive, from a issuing system server, an indication of a request to perform a card lifecycle action in connection with a card account of a user;
provide, based on the indication of the request, an encryption key set to the issuing system server;
receive, from the issuing system server, an encrypted request message signed by the issuing system server and a client device of the user, the encrypted request message comprising data associated with the request to perform the card lifecycle action; and
perform the card lifecycle action based on the encrypted request message being signed by the issuing system server and the client device of the user.

12. The system as recited in claim 11, wherein the instructions that, when executed by the at least one processor, cause the system to receive the indication of the request to perform the card lifecycle action further cause the system to receive an indication of a request to set a personal identification number associated with the card account of the user, a request to activate a payment card associated with the card account of the user, a request to disable a payment card associated with the card account of the user, or a request to view a personal identification number associated with the card account of the user.

13. The system as recited in claim 11, wherein the instructions that, when executed by the at least one processor, cause the system to:
receive the indication of the request by providing a one-time access token to the issuing system server in response to a token request from the issuing system server; and
verify that a header associated with the encrypted request message received from the issuing system server comprises the one-time access token.

14. The system as recited in claim 11, wherein the instructions that, when executed by the at least one processor, cause the system to:
validate that a server signature for the encrypted request message corresponds to the issuing system server;
validate that a client device signature for the encrypted request message corresponds to the client device of the user; and
decrypt the encrypted request message after validating the server signature and the client device signature.

15. The system as recited in claim 14, wherein the instructions that, when executed by the at least one processor, cause the system to perform the card lifecycle action by:
accessing the data associated with the request to perform the card lifecycle action after decrypting the encrypted request message, the data comprising a client identifier of the client device, a user token associated with the user, a card token associated with the card account, and the card lifecycle action; and
performing the card lifecycle action utilizing the accessed data.

16. The system as recited in claim 11, wherein the instructions that, when executed by the at least one processor, cause the system to:
generate a status code in response to performing the card lifecycle action; and
provide the status code to the issuing system server for displaying a response message at the client device of the user according to the status code.

17. A non-transitory computer readable storage medium comprising instructions that, when executed by at least one processor, cause a computing device to:
receive, from a issuing system server, an indication of a request to perform a card lifecycle action in connection with a card account of a user;
provide, based on the indication of the request, an encryption key set to the issuing system server;
receive, from the issuing system server, an encrypted request message signed by the issuing system server and a client device of the user, the encrypted request message comprising data associated with the request to perform the card lifecycle action; and
perform the card lifecycle action based on the encrypted request message being signed by the issuing system server and the client device of the user.

18. The non-transitory computer readable storage medium as recited in claim 17, wherein the instructions that, when executed by the at least one processor, cause the computing device to:
receive the indication of the request to perform the card lifecycle action by receiving an indication of a request to set a personal identification number associated with the card account of the user; and
perform the card lifecycle action by setting the personal identification number associated with the card account of the user based on the data in the encrypted request message.

19. The non-transitory computer readable storage medium as recited in claim 18, wherein the instructions that, when executed by the at least one processor, cause the computing device to perform the card lifecycle action by:
validating that a server signature for the encrypted request message corresponds to the issuing system server;
validating that a client device signature for the encrypted request message corresponds to the client device of the user; and
decrypting the encrypted request message in response to verifying that a header associated with the encrypted request message received from the issuing system server comprises a one-time access token provided to the issuing system server in response to receiving the indication of the request to perform the card lifecycle action.

20. The non-transitory computer readable storage medium as recited in claim 17, wherein the instructions that, when executed by the at least one processor, cause the computing device to:
perform the card lifecycle action utilizing the data from the encrypted request message;
generate a response message comprising a status code associated with performing the card lifecycle action; and
provide the response message to the issuing system server.
